(19) United States
(12) Patent Application Publication
(10) Pub. No.: US 2010/0060735 A1
(43) Pub. Date: Mar. 11, 2010

(54) DEVICE AND METHOD OF MONITORING SURROUNDINGS OF A VEHICLE

(76) Inventor: Koji Sato, Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 12/515,683

(22) PCT Filed: Feb. 19, 2008
(86) PCT No.: PCT/JP2008/052741

§ 371 Date: May 20, 2009

(30) Foreign Application Priority Data
Feb. 23, 2007 (JP) 2007-044441

(51) Int. Cl. H04N 7/18

(52) U.S. Cl. 348/148; 348/E07.085

(57) ABSTRACT

To generate information with high accuracy by compensating for the lack of synchronism between imaging timings of two or more imaging means. A device for monitoring surroundings of a vehicle according to the present invention comprises first imaging means for imaging outside of the vehicle in a first imaging area at a predetermined cycle period; second imaging means for imaging outside of the vehicle in a second imaging area at a predetermined cycle period, said second imaging area and the first imaging area overlapping each other at least partially; and information generating means for generating predetermined information in which a lag between imaging timing of the first imaging means and imaging timing of the second imaging means is corrected based on images of both the first and the second imaging means.

### TECHNICAL FIELD

The present invention relates to a device for monitoring surroundings of a vehicle using more than two imaging means and a method of monitoring surroundings of a vehicle using more than two imaging means.

### BACKGROUND ART

JP 2006-237969 A discloses a device for monitoring surroundings of a vehicle, comprising first imaging means disposed on a side of the vehicle for capturing a first image; second imaging means disposed forward with respect to the first imaging means for capturing a second image; and displaying means for superposing the first and second images and displaying the superposed image.

However, if the imaging timing of the first imaging means and the imaging timing of the second imaging means are not in synchronization with each other in the device disclosed in JP 2006-237969 A, two images which have a lag with respect to each other in time-axis are superposed, which may degrade the accuracy or reliability of the superposed image. In particular, in the case of the vehicle, a lag of 1/30 (sec) between imaging timings of two imaging means, for example, corresponds to a travel distance of about 1.0 m at vehicle speed of 108 km/h and thus has a great influence on the reliability of the superposed image. It is noted that this problem is also true for a configuration in which the target object is recognized from the images of two cameras or three-dimensional information of the target object or distance information is acquired with two cameras, besides the configuration in which the images of two cameras are superposed and displayed as disclosed in JP 2006-237969 A. Specifically, in such a configuration, lack of synchronism between imaging timings of two or more imaging means may lead to recognition errors of the target object, errors in measured distance or the like which exceed permissible limits.

### DISCLOSURE OF INVENTION

Therefore, an object of the present invention is to provide a device for monitoring surroundings of a vehicle and a method of monitoring surroundings of a vehicle which can generate information with high accuracy by compensating for the lack of synchronism between imaging timings of two or more imaging means.

In order to achieve the aforementioned object, according to the first aspect of the present invention, a device for monitoring surroundings of a vehicle is provided which comprises;

first imaging means for imaging outside of the vehicle in a first imaging area at a predetermined cycle period;

second imaging means for imaging outside of the vehicle in a second imaging area at a predetermined cycle period, said second imaging area and the first imaging area overlapping each other at least partially; and

information generating means for generating predetermined information in which a lag between imaging timing of the first imaging means and imaging timing of the second imaging means is corrected based on images of both the first and the second imaging means.

According to the second aspect of the present invention, in the first aspect of the present invention, the information generating means corrects one of the images of the first and the second imaging means in accordance with the lag between imaging timing of the first imaging means and imaging timing of the second imaging means, and uses the corrected image and the other of images of the first and the second imaging means to generate the predetermined information.

According to the third aspect of the present invention, in the first aspect of the present invention, the predetermined information is related to a distance of a target object outside the vehicle.

According to the fourth aspect of the present invention, in the first aspect of the present invention, the predetermined information is an image representative of a scene outside the vehicle, said image being generated by superposing the images obtained from both the first and the second imaging means.

According to the fifth aspect of the present invention, a device for monitoring surroundings of a vehicle is provided which comprises;

a first imaging device for imaging outside of the vehicle in a first imaging area at a predetermined cycle period;

a second imaging device for imaging outside of the vehicle in a second imaging area at a predetermined cycle period, said second imaging area and the first imaging area overlapping each other at least partially; and

an information generating device for generating predetermined information in which a lag between imaging timing of the first imaging device and imaging timing of the second imaging device is corrected based on images of both the first and the second imaging devices.

According to the sixth aspect of the present invention, in the fifth aspect of the present invention, the lag between imaging timing of the first imaging device and imaging timing of the second imaging device is corrected by using an interpolation technique which utilizes a correlation between frames.

The seventh aspect of the present invention is related to

a method of monitoring surroundings of a vehicle, which comprises:

a step of imaging outside of the vehicle at a first timing using a first imaging means;

a step of imaging outside of the vehicle at a second timing which is earlier or later than the first timing using a second imaging means;

a corrected image generating step of correcting an image of the first imaging means based on a lag between the first timing and the second timing; and

an information generating step of generating predetermined information using the corrected image obtained by the corrected image generating step and an image of the second imaging means.

According to the eighth aspect of the present invention, in the seventh aspect of the present invention, the information generating step includes a step of generating information as to a distance of a target object outside the vehicle.

According to the ninth aspect of the present invention, in the seventh aspect of the present invention, the information generating step includes a step of superposing the corrected image obtained by the corrected image generating step and the image of the second imaging means to generate an image to be displayed on a display device.

According to the present invention, a device for monitoring surroundings of a vehicle and a method of monitoring surroundings of a vehicle are obtained which can generate information with high accuracy by compensating for the lack of synchronism between imaging timings of two or more imaging means.

### BRIEF DESCRIPTION OF THE DRAWINGS

These and other objects, features, and advantages of the present invention will become more apparent from the following detailed description of preferred embodiments given with reference to the accompanying drawings, in which:

FIG. 1 is a system diagram of a first embodiment of a device for monitoring surroundings of a vehicle according to the present invention;

FIG. 2 is a plan view for schematically illustrating an example of a mounting manner of cameras 10 and imaging areas of the cameras 10;

FIG. 3 is a diagram for schematically illustrating an example of an image displayed on a display 20;

FIG. 4 is a plan view for schematically illustrating a relative movement of a target object with respect to the vehicle as well as a difference between the imaged positions of the target object due to the lack of synchronism between imaging timings of the respective cameras 10FR and 10SR;

FIG. 5 is a diagram for illustrating an example of imaging timings of the respective cameras 10 (10FR, 10SL, 10SR and 10RR);

FIG. 6 is a flowchart of a basic process for implanting a function of compensating for the lack of synchronism which is executed by an image processing device 30;

FIGS. 7A, 7B and 7C are diagrams used for explaining the function of compensating for the lack of synchronism shown in FIG. 6;

FIG. 8 is a system diagram of a second embodiment of a device for monitoring surroundings of a vehicle according to the present invention;

FIG. 9 is a plan view for schematically illustrating an example of a mounting manner of cameras 40 and imaging areas of the cameras 40 according to the second embodiment;

FIG. 10 is a diagram for illustrating an example of imaging timings of the respective cameras 41 and 42; and

FIG. 11 is a flowchart of a basic process for compensating for the lack of synchronism which is executed by an image processing device 60.

### EXPLANATION FOR REFERENCE NUMBER

10, 40 camera
20 display
30, 60 image processing device
50 pre-crash ECU

### BEST MODE FOR CARRYING OUT THE INVENTION

In the following, the best mode for carrying out the present invention will be described in detail by referring to the accompanying drawings.

### First Embodiment

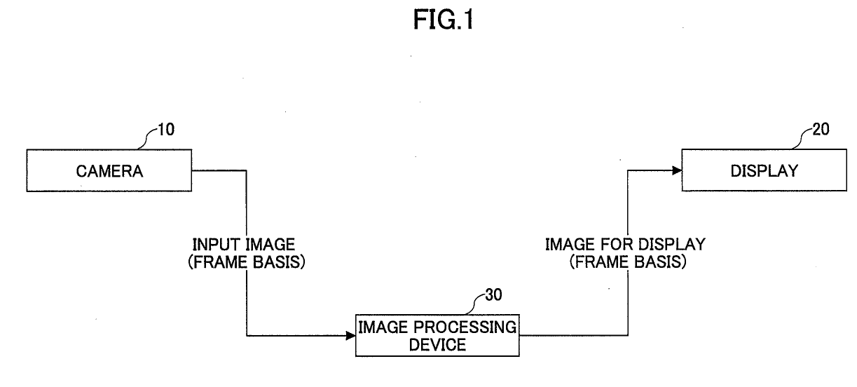

FIG. 1 is a system diagram of a first embodiment of a device for monitoring surroundings of a vehicle according to the present invention. The device for monitoring the surroundings of a vehicle according to this embodiment is provided with an image processing device 30. The image processing device 30 outputs an image (video) of the surroundings of the vehicle via a display 20 mounted on the vehicle, based on images obtained from the cameras 10 mounted on the vehicle. The display 20 may be a liquid crystal display, and is mounted at a position which is easy to be viewed by an occupant, such as an instrument panel or a position near a meter.

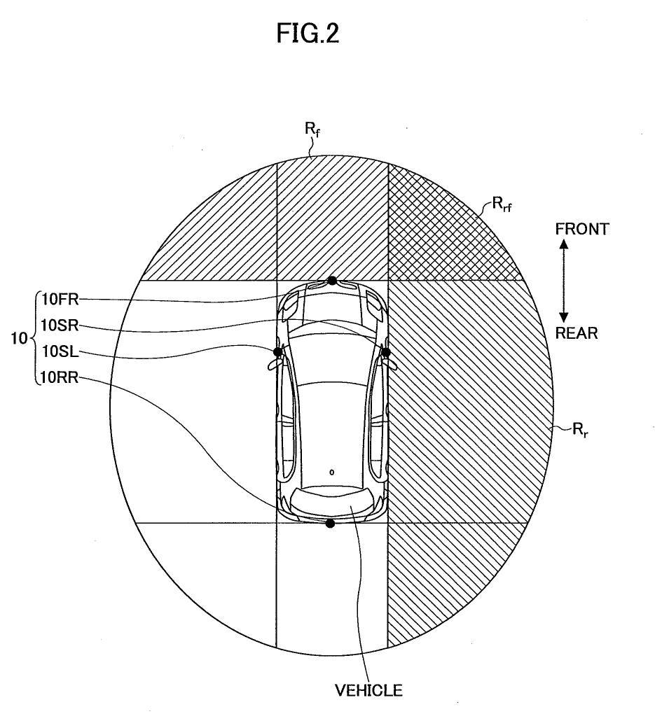

FIG. 2 is a plan view for schematically illustrating an example of a mounting manner of cameras 10 and imaging areas of the cameras 10. The cameras 10 are provided on a front portion, each side portion, and a rear portion of the vehicle, and thus the total number of the cameras 10 is 4, as shown in FIG. 2. The respective cameras 10 (10FR, 10SL, 10SR and 10RR) capture images of surroundings including road surfaces using imaging elements such as CCD (charge-coupled device) or CMOS (complementary metal oxide semiconductor). The respective cameras 10 may be wide-angle cameras with fisheye lenses. The respective cameras 10 (10FR, 10SL, 10SR and 10RR) may supply the image processing device 30 with images in a stream form at a predetermined frame rate (for example, 30 fps).

The front camera FR is provided on the front portion of the vehicle body (the portion near the bumper) such that it captures the image of surroundings including the road surface in front of the vehicle, as shown schematically in FIG. 2. The left side camera SL is provided on a door mirror body on the left side such that it captures the image of surroundings including the road surface on the left side of the vehicle, as shown schematically in FIG. 2. The right side camera SR is provided on a door mirror body on the right side such that it captures the image of surroundings including the road surface on the right side of the vehicle, as shown schematically in FIG. 2. The rear camera RR is provided on the rear portion of the vehicle body (the portion near the rear bumper or a back door) such that it captures the image of surroundings including the road surface behind the vehicle, as shown schematically in FIG. 2.

In FIG. 2, an example of imaging areas of the respective cameras 10 is schematically illustrated. In the example shown in FIG. 2, the respective cameras are wide-angle cameras whose respective imaging areas are shown in the shape of a sector. In FIG. 2, the imaging area Rf of the front camera 10FR and the imaging area Rr of the right side camera 10SR are featured by hatch patterns. These respective imaging areas may have an overlapping area (the area Rrf in FIG. 2, for example), as shown in FIG. 2. In this way, in the example shown in FIG. 2, the all-around scene outside the vehicle is captured by the four cameras 10FR, 10SL, 10SR and 10RR in cooperation with each other.

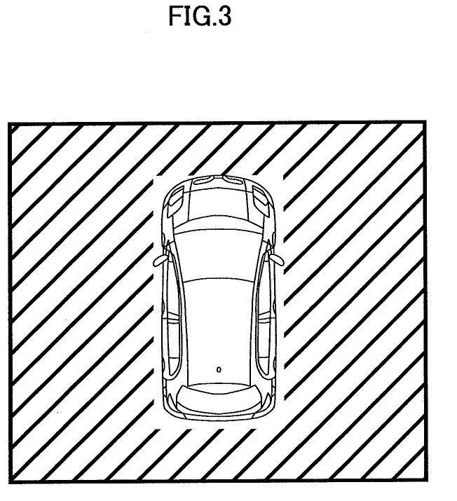

FIG. 3 is a diagram for schematically illustrating an example of an image displayed on a display 20. The image to be displayed is generated by superposing the images obtained via four cameras 10FR, 10SL, 10SR and 10RR. In the example shown in FIG. 3, an image representing the vehicle (i.e., a vehicle image) is incorporated in the center area of the displayed image. Such a vehicle image may be an image which is created in advance and stored in a predetermined memory. The displayed image is obtained by placing the vehicle image in a center area, and placing images obtained from the respective cameras 10 in other corresponding areas. The images obtained from the respective cameras 10 are subjected to appropriate pre-processing (such as coordinate conversion, distortion correction, perspective correction, etc.) so as to be an image for display in a bird's eye view in which the road surface is viewed from sky, and then displayed on the display 20. It is noted that the portions featured by hatch patterns represent the image portions of the road surface or objects on the road viewed by bird's eyes. In this way, the occupant can understand the status of the road surface or the status of the objects on the road (for example, various types of road partition lines or positions of various types of obstacles) over all azimuths around the vehicle center.

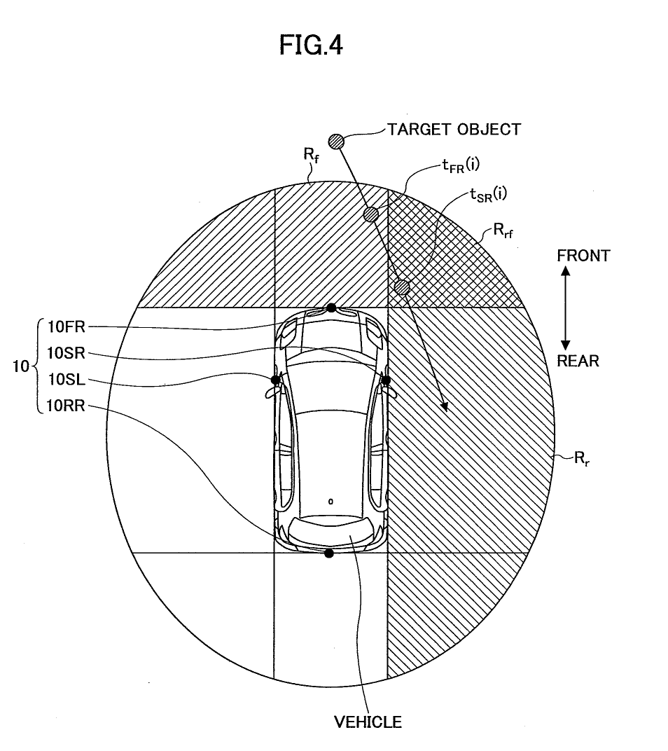

By the way, in such a configuration in which a displayed image is created by superposing the images obtained by two or more cameras 10FR, 10SR, etc., as mentioned above, if the imaging timings of the respective cameras 10 (10FR, 10SL, 10SR and 10RR) are out of sync, there may be a problem such as discontinuity at the boundaries between the respective images or multiple display of the same target object because of superposition of images with a time lag. For example, a case is assumed where the target object outside the vehicle enters the imaging area of the camera 10FR at the imaging timing t_{FR}(i) of the frame period (i) of the camera 10FR, and enters the overlapped imaging area Rrf of the cameras 10FR and 10SR at the imaging timing t_{SR}(i) of the frame period (i) of the camera 10SR, as shown in FIG. 4. The imaging timing t_{SR}(i) of the camera 10SR is assumed to be delayed with respect to the imaging timing t_{FR} (i) of the same frame period of the camera 10FR due to the lack of synchronism. In this case, if the respective images captured at the same frame period by the camera 10FR and camera 10SR are merely superposed, one target object is displayed as if there were two (i.e., multiple displays of the same target object). If this type of lack of synchronism occurs, there may be a case where it is technically difficult to maintain synchronism by correcting the imaging timing.

Thus, in the present embodiment, the problem which occurs if the imaging timings of the respective cameras 10 are not in synchronization with each other is eliminated by providing the image processing device with a function of compensating for the lack of synchronism while permitting this type of lack of synchronism. In the following, the function of compensating for the lack of synchronism is described in detail.

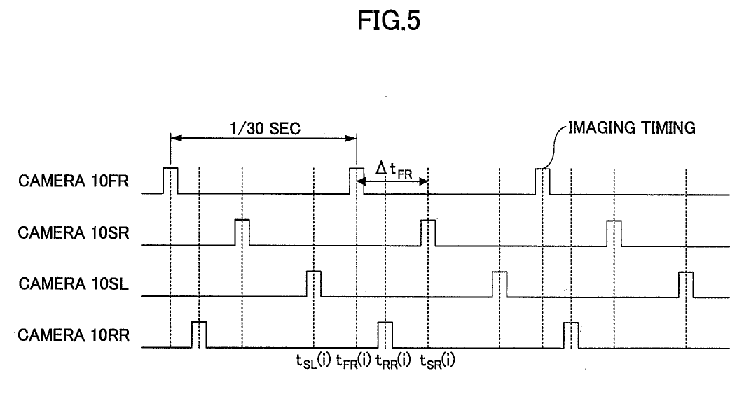

FIG. 5 is a diagram for illustrating an example of imaging timings of the respective cameras (10FR, 10SL, 10SR and 10RR). In the example shown in FIG. 5, the respective cameras 10 (10FR, 10SL, 10SR and 10RR) have the same frame rate of 30 fps but are not in synchronization with each other. In this case, there may be a lag of 1/30 second at the maximum because of the frame rate of 30 fps.

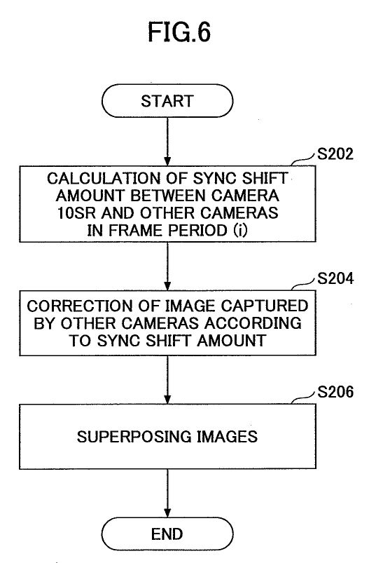

FIG. 6 is a flowchart of a basic process for compensating the lack of synchronism which is executed by the image processing device 30. In the following, a case where the superposed image is generated with reference to the camera 10SR among the respective cameras 10 (10FR, 10SL, 10SR and 10RR) is described. However, the reference camera is arbitrary. The process routine shown in FIG. 6 is executed repeatedly every imaging timing of the camera 10SR.

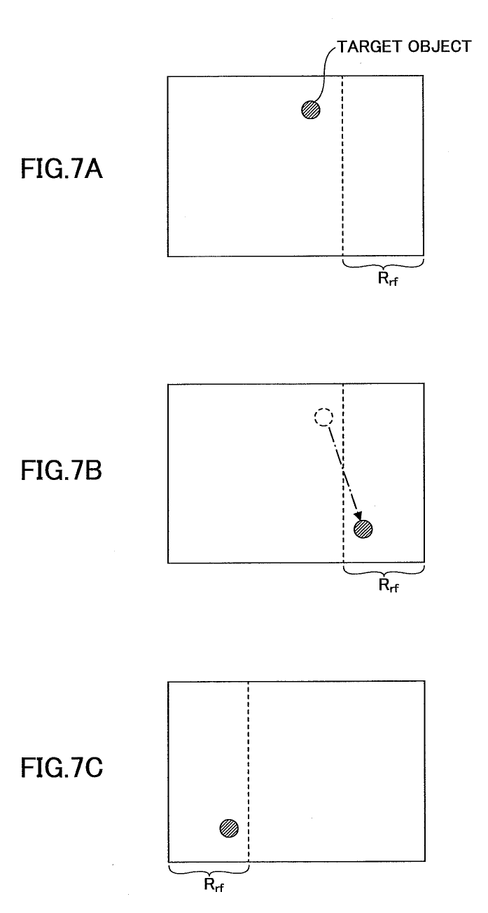

FIGS. 7A, 7B and 7C are diagrams used for explaining the function of compensating for the lack of synchronism shown in FIG. 6. FIG. 7A is a diagram for schematically illustrating the image captured at frame period (i) of the camera 10FR, FIG. 7B is a diagram for schematically the corrected image of the camera 10FR which is obtained through the correction process of step 204 as mentioned below, and FIG. 7C is a diagram for schematically illustrating the image captured at frame period (i) of the camera 10SR. In the example shown in FIGS. 7A, 7B and 7C, the target object as shown in FIG. 4 is imaged. In the respective drawings of FIGS. 7A, 7B and 7C, the image portion corresponding to the overlapped area Rrf is indicated by a dotted line.

With reference to FIG. 6, in step 202, the lags of the imaging timings of the respective cameras 10 (10FR, 10SL, 10SR and 10RR) at the same frame period (i) are calculated. Here, the lags are calculated with reference to the imaging timing of the camera 10SR. For example, in the example shown in FIG. 5, the sync shift amount Δt_{FR} of the camera FR is calculated as Δt_{FR}=t_{SR}(i)−t_{FR}(i). It is noted that the imaging timings (t_{SR}(i), etc.) of the respective cameras 10 (10FR, 10SL, 10SR and 10RR) may be detectable using a time stamp or the like. Alternatively, the sync shift amount Δt may be calculated by evaluating correlation in the overlapped area of the respective captured images.

In step 204, the captured images of the cameras 10FR, 10SL and 10RR at frame period (i) are corrected based on the sync shift amount calculated in step 202. For example, regarding the captured image of the camera 10FR, the image I (i) (see FIG. 7A) captured by the camera 10FR at this frame period (i) is corrected such that it corresponds to an image (see FIG. 7B) which would be obtained if it were captured in synchronism with the imaging timing t_{SR}(i) of the camera 10SR. This correction is implemented by using an interpolation technique which utilizes a correlation (for example, a cross-correlation function) between frames, for example. For example, the correction may be implemented in a manner known from MPEG in which a P (Predictive) frame is derived from an I (Intra) frame, where the P frame corresponds to an imaginary frame at time t_{SR}(i), which is later than time t_{FR} by Δt_{FR} and the I frame corresponds to the image I (i) obtained at time t_{FR}(i) in this example. It is noted that for the inter frame prediction in MPEG the motion compensation technique (which is a technique for estimating and compensating for a motion vector of the target object) considering the relationship between the sync shift amount Δt and a frame period interval may be used. Then, the current vehicle speed which can be derived from the wheel speed sensors, for example, may be considered. It is noted that the corrected image (see FIG. 7B) thus obtained may be subjected to a further correction by evaluating the correlation of pixel information (for example, luminance signals or color signals) in the overlapped area Rrf with respect to the image (see FIG. 7C) captured at frame period (i) by the camera 10SR.

In step 206, an image to be displayed is generated using the respective corrected images associated with the respective captured images of the cameras 10FR, 10SL and 10RR obtained in step 204 and the captured image of camera 10SR. Then, for the overlapped areas (the area Rrf in FIG. 2, for example) of the respective cameras 10, any one of the images may be selected to generate an image portion corresponding to the overlapped area in the resultant displayed image, or both of them may be used in cooperation to generate an image portion corresponding to the overlapped area in the resultant displayed image. For example, for the overlapped area Rrf of the camera 10SR and the camera 10FR, any one of the image portion corresponding to the overlapped area Rrf in the corrected image of the camera 10FR shown in FIG. 7B and the image portion corresponding to the overlapped area Rrf in the captured image of the camera 10SR shown in FIG. 7C may be used for rendering, or both of these image portions may be used in cooperation for rendering.

In this way, according to the present embodiment, even if the imaging timings of the respective cameras 10 (10FR, 10SL, 10SR and 10RR) are out of sync with each other, since the displayed image is generated using the corrected image in which the lag of the imaging timing is corrected, it is possible to eliminate the problem which occurs if the imaging timings of the respective cameras 10 are out of sync with each other. Thus, it is possible to generate the highly accurate displayed image (which doesn't make a viewer feel abnormal) which is free from discontinuity at the boundaries between the respective images and from multiple displays of the same target object.

It is noted that although in the present embodiment the camera whose imaging timing is the latest in time within the same frame period (corresponding to the camera 10SR in this example) is made a reference in correcting the images captured by other cameras (corresponding to the cameras 10FR, 10SL and 10RR in this example), one of the other cameras (corresponding to the cameras 10FR, 10SL and 10RR in this example) may be made a reference. For example, if the imaging timing of the camera 10FR is made a reference, the captured image of the camera 10SL may be corrected in a manner (forward prediction) in which a P frame which is delayed by the sync shift amount is derived as mentioned above, while the captured images of the cameras 10SR and 10RR may be corrected in a manner (backward prediction) in which P frame which precedes by the sync shift amount is derived or in a manner (bidirectional prediction) in which a B (bidirectional predictive) frame is derived using the captured images at the previous frame period and the captured images at this frame period.

Further, in the present embodiment, it is also possible to display an image which is generated by superposing the images captured at different frame periods. For example, in the case of the lack of synchronism shown in FIG. 5, at the time when the image is captured by the camera 10SR, the captured images of the cameras 10FR, 10SL and 10RR at the next frame period may be corrected in a manner (backward prediction or bidirectional predictive) in which a P frame which precedes by the sync shift amount is derived, and then the resultant corrected images and the captured image of the camera 10SR may be superposed to be displayed.

### Second Embodiment

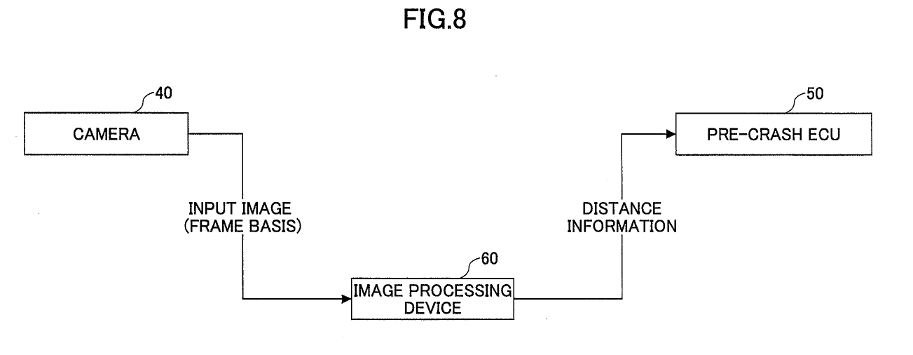

FIG. 8 is a system diagram of a second embodiment of a device for monitoring surroundings of a vehicle according to the present invention. The device for monitoring surroundings of a vehicle according to this embodiment is provided with an image processing device 60. The image processing device 60 recognizes the target object in the captured image captured by cameras 40 mounted on the vehicle using an image recognition technique and generates information (referred to as “distance information” hereafter) as to a distance to the target object outside the vehicle. The target object may be an object on the ground such as other vehicles, pedestrians, buildings, road signs including painted signs or the like. The distance information is supplied to a pre-crash ECU 50 which uses it for pre-crash control. The distance information may be used instead of the distance data of a clearance sonar or may be used for other control such as adaptive cruise control for maintaining the distance between vehicles, lane keep assist control, etc. The pre-crash control includes outputting an alarm, increasing the tension of a seat belt, driving the bumper to the adequate height, generating the brake force, etc., prior to the crash with an obstacle.

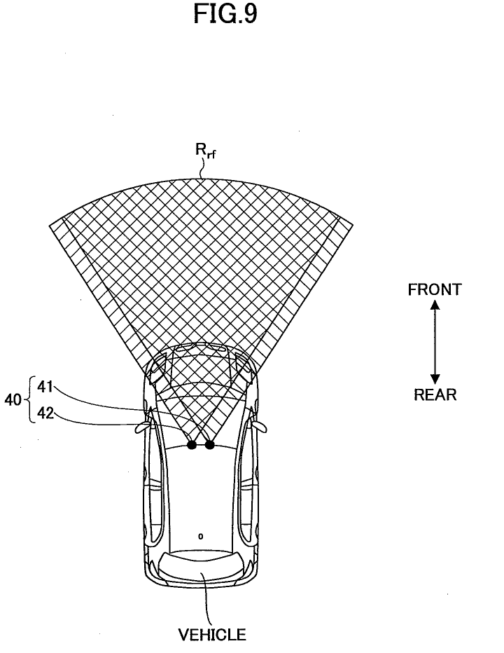

FIG. 9 is a plan view for schematically illustrating an example of a mounting manner of the cameras 40 and imaging areas of the cameras 40. The cameras 40 may be a stereo camera consisting of two cameras 41 and 42 disposed apart from each other in a transverse direction of the vehicle, as shown in FIG. 9. The respective cameras 41 and 42 capture corresponding images of the surroundings in front of the vehicle using imaging elements such as CCD or the like. The cameras 40 are provided near the upper edge of the windshield glass of a cabin, for example. The respective cameras 41 and 42 may supply the image processing device 60 with corresponding images in a stream form at a predetermined frame rate (for example, 30 fps).

In FIG. 9, an example of imaging areas of the respective cameras 41 and 42 is schematically illustrated. In the example shown in FIG. 9, imaging areas of the respective cameras 41 and 42 are shown in the shapes of sectors. The imaging areas of the respective cameras 41 and 42 may have overlapping area (the area Rrf in FIG. 9, for example), as shown in FIG. 9. In this way, in the example shown in FIG. 9, the scene in front of the vehicle is captured by two cameras 41 and 42 with parallax.

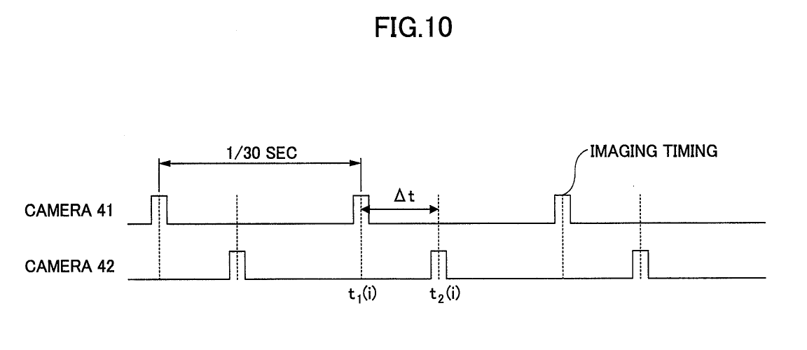

FIG. 10 is a diagram for illustrating an example of imaging timings of the respective cameras and 42. In the example shown in FIG. 10, the respective cameras 41 and 42 have the same frame rate of 30 ftp but are not in synchronization with each other. In this case, there may be a lag of 1/30 sec at the maximum because of the frame rate of 30 fps.

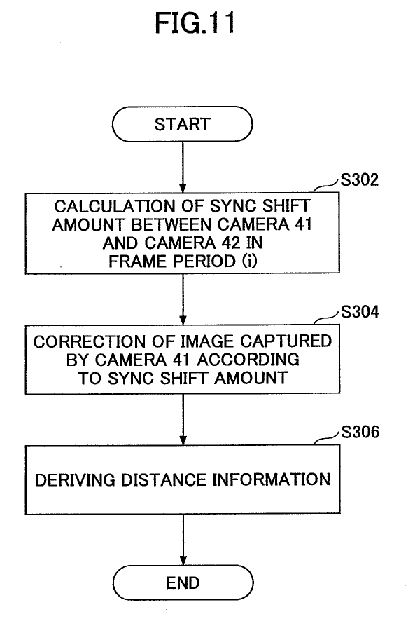

FIG. 11 is a flowchart of a basic process for compensating for the lack of synchronism which is executed by the image processing device 60. In the following, a case where the distance information is generated with reference to the left camera 42 of the cameras 41 and 42 is described. However, the reference camera is arbitrary. The process routine shown in FIG. 11 is executed repeatedly every imaging timing of the left camera 42.

In step 302, the lag between the imaging timings of the respective cameras 41 and 42 within the same frame period (i) is calculated. For example, in the example shown in FIG. 10, the sync shift amount Δt of the right camera 41 is calculated as Δt=t₂(i) t₁(i). It is noted that the imaging timings (t₂(i), etc.) of the respective cameras 41 and 42 may be detectable using a time stamp or the like.

In step 304, the captured image of the camera 41 at frame period (i) is corrected based on the sync lag amount calculated in step 302. The way of correcting the captured image in accordance with the sync lag amount may be the same as the way in the aforementioned first embodiment.

In step 306, the distance information is generated using the corrected captured image of the camera 41 obtained in step 304 and the captured image of the camera 42. This distance information may be generated in a manner as is the case where a stereo camera is used in which the imaging timings of two cameras are in synchronization. The difference with respect to the case where the stereo camera is used in which the imaging timings of two cameras are in synchronization is that the captured image of the camera 41 is corrected as mentioned above.

In this way, according to the present embodiment, even if the imaging timings of the respective cameras 41 and 42 are out of sync with each other, since the distance information is generated using the corrected image in which the lag of the imaging timing is corrected, it is possible to eliminate the problem which occurs if the imaging timings of the respective cameras 41 and 42 are out of sync with each other. Consequently, it is possible to generate the distance information with high accuracy.

It is noted that in the aforementioned embodiments the “information generating means” in claims is implemented when the image processing device 30 or 60 performs the process in FIG. 6 or the process in FIG. 9.

The present invention is disclosed with reference to the preferred embodiments. However, it should be understood that the present invention is not limited to the above-described embodiments, and variations and modifications may be made without departing from the scope of the present invention.

For example, although in the aforementioned embodiments the images captured by two or more cameras are used in cooperation to display the superposed image or generate the distance information, the present invention is applicable to any application in which the images captured by two or more cameras which are out of sync or are not synchronized are used in cooperation.

Further, although in the aforementioned embodiments the frame rate is the same for the cameras (10FR, 10SL, 10SR and 10RR), etc., the frame rate may be different among them. Further, although in the aforementioned first embodiment the imaging timings of the respective cameras 10 (10FR, 10SL, 10SR and 10RR) are different from each other, the effect of the present invention can be obtained as long as the imaging timing of at least one of the cameras is different from others.

The present application is based on Japanese Priority Application No. 2007-44441, filed on Feb. 23, 2008, the entire contents of which are hereby incorporated by reference.

1. A device for monitoring surroundings of a vehicle, comprising:
first imaging means for imaging outside of the vehicle in a first imaging area at a predetermined cycle period;
second imaging means for imaging outside of the vehicle in a second imaging area at a predetermined cycle period, said second imaging area and the first imaging area overlapping each other at least partially; and
information generating means for generating predetermined information in which a lag between imaging timing of the first imaging means and imaging timing of the second imaging means is corrected based on images of both the first and the second imaging means.

2. The device for monitoring surroundings of a vehicle as claimed in claim 1, wherein the information generating means corrects one of the images of the first and the second imaging means in accordance with the lag between the imaging timing of the first imaging means and the imaging timing of the second imaging means, and uses the corrected image and the other of the images of the first and the second imaging means to generate the predetermined information.

3. The device for monitoring surroundings of a vehicle as claimed in claim 1, wherein the predetermined information is related to a distance of a target object outside the vehicle.

4. The device for monitoring surroundings of a vehicle as claimed in claim 1, wherein the predetermined information is an image representative of a scene outside the vehicle, said image being generated by superposing the images obtained from both the first and the second imaging means.

5. A device for monitoring surroundings of a vehicle, comprising:
a first imaging device for imaging outside of the vehicle in a first imaging area at a predetermined cycle period;
a second imaging device for imaging outside of the vehicle in a second imaging area at a predetermined cycle period, said second imaging area and the first imaging area overlapping each other at least partially; and
an information generating device for generating predetermined information in which a lag between imaging timing of the first imaging device and imaging timing of the second imaging device is corrected based on images of both the first and the second imaging devices.

6. The device for monitoring surroundings of a vehicle as claimed in claim 5, wherein the lag between the imaging timing of the first imaging device and the imaging timing of the second imaging device is corrected by using an interpolation technique which utilizes a correlation between frames.

7. A method of monitoring surroundings of a vehicle, comprising:
a step of imaging outside of the vehicle at a first timing using a first imaging means;
a step of imaging outside of the vehicle at a second timing which is earlier or later than the first timing using a second imaging means;
a corrected image generating step of correcting an image of the first imaging means based on a lag between the first timing and the second timing; and
an information generating step of generating predetermined information using the corrected image obtained by the corrected image generating step and an image of the second imaging means.

8. The method of monitoring surroundings of a vehicle as claimed in claim 7, wherein the information generating step includes a step of generating information as to a distance of a target object outside the vehicle.

9. The method of monitoring surroundings of a vehicle as claimed in claim 7, wherein the information generating step includes a step of superposing the corrected image obtained by the corrected image generating step and the image of the second imaging means to generate an image to be displayed on a display device.
